(19) United States
(12) Patent Application Publication
(10) Pub. No.: US 2007/0267492 A1
(43) Pub. Date: Nov. 22, 2007

(54) System and Method for Electronic Voting

(76) Inventor: Pieter Gerard Maclaine Pont, Wijckel (NL)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/563,680

(22) PCT Filed: Jul. 8, 2004
(86) PCT No.: PCT/NL04/00496

§ 371 Date: Feb. 22, 2007

(30) Foreign Application Priority Data
Jul. 8, 2003 (NL) 1023861

(51) Int. Cl. G07C 13/00

(52) U.S. Cl. 235/386

(57) ABSTRACT

Electronic voting system and method for collecting and counting votes from individual voters using electronic polling equipment. The system comprises means for validating votes from collected virtual ballot forms. The validating means are arranged in such way that if a set of two or more virtual ballot forms associated with an identical voter is collected, one virtual ballot form of this set is validated as one valid vote of the voter. The remaining virtual ballot forms of the set are marked as duplicate, provided the virtual ballot forms of the set are identical as to the subject elected by the voter. Otherwise all virtual ballot forms of the set are marked invalid. Thereby effectively preventing double counting of valid votes, among others, due to network problems causing a virtual ballet form to be forwarded twice or even many more times.

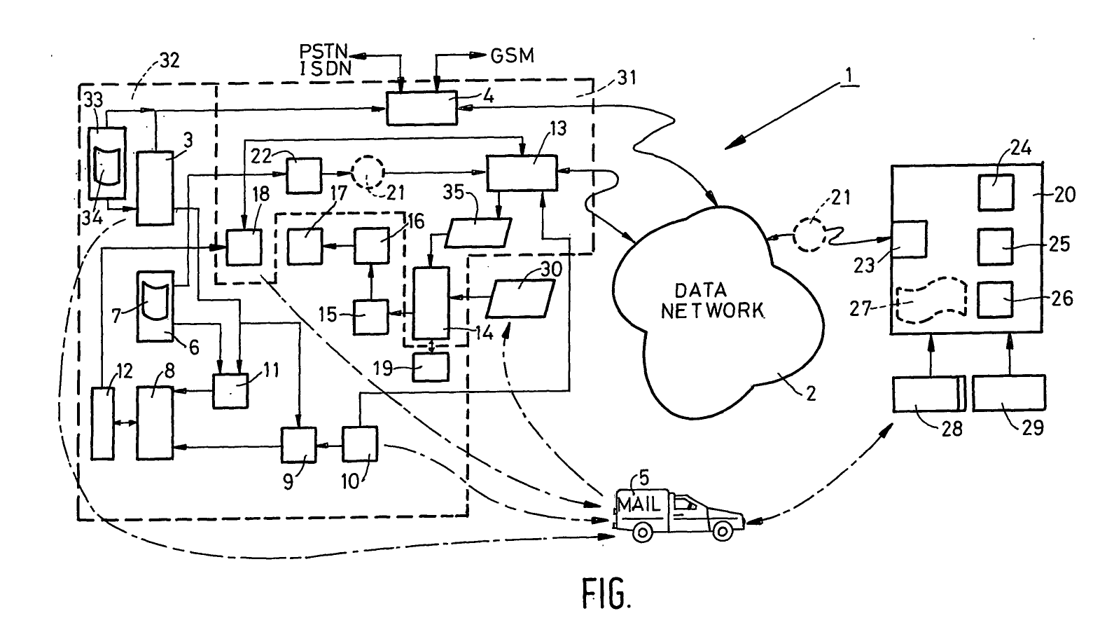

### FIELD OF THE INVENTION

The present invention generally relates to electronic voting and, more particularly, to electronic voting in an election via a public data network such as the Internet.

### BACKGROUND OF THE INVENTION

In the context of the present invention, an election is to be construed as an election for a public or governmental body, an opinion poll, a referendum, a company election for an employees council or the like and any other type of election wherein persons may choose between two or more alternatives or options and communicate their choice as a vote to a vote collecting authority.

An important aspect is that the participation to the election is restricted to persons which have been registered beforehand as voters entitled to participate in the voting.

At present, an election for a public body, for example, requires that a person has to report himself at a polling station for filling in a ballot form or to vote electronically by pushing one or more buttons on a voting machine. For expats, that is voters who live abroad, for example, the votes may be forwarded by mail to a central polling station and will be counted together with the collected ballot forms and electronic votes in the total election result.

Although electronic voting machines have improved the speed of counting the votes, for example, they still require that the voters report themselves at a polling station for making their choices.

With the advent of modern electronic communication techniques, in particular the Internet, methods and systems have been developed by which voters can vote from their homes, using electronic communication equipment like Personal Computers (PC's), landline and mobile telephones, and the like.

European patent application EP 1 291 826 discloses an electronic voting system wherein the Internet is used as a communication medium between the remote home voters and the vote collecting authority. Several measures have been proposed and implemented to guarantee the correct identity of the voter, to avoid fraude and to reduce the risk of a virus or a malicious hacker to intercept and amended the electronic votes, for example.

In a paper “Electronic elections employing DES smartcards”, by Robers, H., December 1998, IBM Student Chipcard Innovation Team, a location independent electronic voting system is disclosed, using chipcard technology.

In the context of the present invention, the term “electronic vote” has to be construed as a vote electronically communicated via an electronic voting system from a remote voter to a vote collecting authority.

For a successful implementation of electronic voting, the system should meet the requirements that can be expected for a formal government election system, for example, in which voting by mail is allowed as well. In addition, the technology used should be such, that more than 95% of the expected potential of users should be able to use the system on their regular Internet connected PC, without any changes or installation requirements to be performed by the users.

Such PC's can expected to be equipped with a regular Internet browser, like Microsoft's Internet Explorer®, with features like Java® and acceptance of cookies typically turned off. In addition, most of them will be connected to the Internet with either a dial-up or a slow ADSL or cable connection. In addition, the system should behave for the user like a “normal” interactive Internet application, with “normal” response properties, since the use of the election system will be a “one-time shot” over longer periods such as months or years.

Given the relative low turnout, there is a high risk of losing the potential voter in case his Internet access to the election is behaving “funny” in his or hers observation. So the client environment will put a serious limitation on the actual possibilities at the client side for an electronic voting system.

Not only the client environment, but also the Internet itself and the intermediate providers may cause problems while a vote is being communicated to the vote collecting authority.

As will be recognized by most of the users of email messages, for example, sometimes a message will not arrive at all and is lost on the Internet, and sometimes a single message will be delivered twice or many more times due to an erroneous behavior of the communication equipment involved from the voter up to the vote collecting authority.

The electronic voting system as disclosed by European patent application EP 1 291 826 and Robers, H., amongst others, has no provisions how to deal with electronic votes from the same remote voter that arrive at the vote collecting authority twice or even repeatedly.

Other shortcomings of the cited prior art comprise:
no vote and result validation of the final election results, both for each voter and other parties to an election;
difficult to combine with other voting manners (mail, electronically, GSM, SMS, etc. to one result with manageable priority;
no facilities to provide for an alternative election package for voters who claim not to have received the original one, for example, which package contains the initial secrets, required by each voter to take part in the elections, and
no capability to implement an election scheme in such a way that each voters secret remains in his/hers possession or at least in his polling equipment, without any other requirement then the use of a regular internet browser on that PC.

Further, systems entirely based on intelligent chip card (or smart card), such as described by Robers, H., require that the user must have a chip card interface device attached to his/hers PC. This is a major cost factor, in particular for election on a large scale, many entitled voters, such as a governmental election. Practically, such voting systems are only feasible for a minor group of (specialized) voters. Further, on each smart card the organizer of the elections needs to pose a secret cryptographic key-distribution key. Although feasible in practice, this too adds significantly to the costs and complexity of the system.

### SUMMARY OF THE INVENTION

In the light of the above disclosed conditions, it is an object of the present to provide an improved electronic voting system, by which remote users can electronically communicate their votes to a vote collecting authority, and meeting as much as possible all major theoretical requirements that can be defined in view of a well controllable democratic election system.

In practice, there will be a trade off between requirements which will be met by a proper design and implementation of the electronic voting system, and requirements which can be met through organizational measures. However, the electronic voting system according to the invention should be expected to be designed and applied in such a way that an optimum between system functions and organizational measures is obtained at reasonable costs.

The following goals should at least be met, either by the electronic voting system itself, or by a combination with other, organizational, measures:
only eligible persons can vote;
no person can vote more than once;
the vote is secret;
each (correctly cast) vote gets counted, and
the voters trust that their vote is counted.

Based on the location independent electronic voting system described in the above-mentioned paper by Robers, H., these objects and others are achieved, in accordance with a first aspect of the present invention, by an electronic voting system for collecting and counting votes from individual voters using electronic polling equipment in an election comprising a list of subjects to be elected, from which list one subject is to be elected by an individual voter, wherein the votes being forwarded by means of a data network, and the voting system comprises:
means for generating a unique personal key for each individual voter entitled to the election, which unique personal key is to be communicated to the individual voter;
means for generating a unique subject code for each subject on the list of subjects to be elected in the election;
means for generating a reference election record for each individual voter comprising all potential virtual ballot forms for the individual voter, wherein a unique voter identity code for the individual voter is calculated from a unique code for the election and the unique personal key of the voter, wherein a unique subject identity code for each subject on the list of subjects to be elected by the voter in the election is calculated from the unique subject codes and the unique personal key of the voter, and wherein the calculated identity codes form part of the virtual ballot forms;
means for storing the reference election records for the individual voters;
means for loading a tool in the polling equipment of the individual voter wherein the tool comprises means for calculating the unique voter identity code of the voter from the election code and the unique personal key communicated to the voter, for calculating the unique subject identity code of the subject elected by the voter from the unique subject code of the subject elected by the voter and the unique personal key of the voter and for generating the virtual ballot form comprising the calculated identity codes by using the polling equipment;
means for forwarding the virtual ballot form by the polling equipment over the data network;
means for receiving and collecting the virtual ballot form forwarded by the polling equipment;
means for verifying each collected virtual ballot form with respect to its presence in the reference election records of the voters;
means for counting votes, and
means for establishing an election result, characterized by means for validating votes from the collected virtual ballot forms, which validating means are arranged in such way that if a set of two or more virtual ballot forms associated with an identical voter identity code is collected, one virtual ballot form of the set is validated as one valid vote of the voter and the remaining virtual ballot forms of the set are marked as duplicate, provided the virtual ballot forms of the set are identical as to the subject elected by the voter, otherwise all virtual ballot forms of the set are marked invalid.

In the context of the present invention, the term “virtual ballot form” is to be construed as an electronic or “soft” ballot form, contrary to a paper or “hard” ballot form, for example.

To avoid double counting of votes, in accordance with the present invention, a set of virtual ballot forms collected by the means for receiving and collecting are validated in a such a manner that if multiple virtual ballot forms are received from the same voter, these ballot forms will be counted as a single valid vote, provided the received virtual ballot forms are identical. Otherwise, all received virtual ballot forms of the set are marked invalid and no valid vote will be counted for this voter.

The election system according to the invention is now capable to deal with communication irregularities causing two or more identical votes from the same votes being collected, for example, such that no person can vote twice. That is, can provide multiple electronic votes that are all validly counted.

As will be appreciated by those skilled in the art, with the election system according to the invention, by generating a personal key for each voter, by calculating a unique voter identity code for the individual voter from a unique code for the election and the unique personal key of the voter, by generating unique subject codes for each subject taking part in the election and by calculating unique subject identity codes of the subjects to be elected by a particular voter from his/hers personal key and the subject identity codes, which identity codes form part of the virtual ballot form, a very secure and safe voting system is provided.

Security is particularly strengthened by when using cryptographic algorithms and encryption techniques such as, but not limited to, symmetric cryptographic algorithms, like the Data Encryption Standard (DES), triple DES, or the Advanced Encryption Standard (AES), using Message Authentication Codes (MACs) and Modification Detection Codes (MDCs), also called hashing codes.

The reference election record provides a first check whether collected virtual ballot forms are indeed a possible vote for a respective voter, whereas the means for validating the votes in accordance with the invention effectively prevent double voting of virtual ballot forms which are within the reference election record of that particular voter.

Accordingly, the electronic voting system according to the invention can be safely used even with distorted public network facilities, while meeting the requirements of preventing double counting of the same or different votes of a voter.

In a further embodiment of the invention, the electronic voting system is arranged for collecting and counting votes in an election wherein one combination of subjects is to be elected by an individual voter, comprising validating means, arranged in such way that if a set of two or more virtual ballot forms associated with an identical voter identity code is collected, one virtual ballot form of the set is validated as one vote of the voter and the remaining virtual ballot forms of the set are marked as duplicate, provided the virtual ballot forms of the set are identical as to the one combination of subjects elected by the voter, otherwise all virtual ballot forms of the set are marked invalid.

In accordance with further embodiments of the invention, the validating means may form part of the means for verifying the collected virtual ballot forms or may form part of the means for counting the votes. This, reducing the number of means actually involved in the election and thereby reducing the risk of malicious attacks on multiple parts of the system, for example.

To inform the voter of the receipt of his or hers vote, in a yet further embodiment of the invention, the voting system comprises confirmation means for generating a receipt indicating that a virtual ballot form has been received from the polling equipment of the voter and means for delivering the receipt comprising a unique receipt confirmation value in readable form at the polling equipment of the voter.

A very important aspect of electronic voting or election systems for use in public elections, for example, is the possibility that voters have an opportunity to inspect whether they have been correctly registered and which votes they can make. This is achieved, in yet another embodiment of the invention, by comprising means for publishing the list of voters entitled to the election, the list of subjects to be elected in the election and the reference election records for the individual voters, enabling public inspection before the date of the election, and by entry means for each individual voter using the unique personal key for inspection of the reference election record for the individual voter.

It will be appreciated that voters also have to be provided with an opportunity to inspect, once they have voted, whether their votes are correctly counted. To this end, in a further embodiment of the invention, the voting system comprises means for publishing the election-result comprising the record of the valid votes as awarded for the collected virtual ballot forms after they have been submitted for verification and validation, enabling public inspection, and entry means for each individual voter using the unique personal key for inspection of the account of the virtual ballot form forwarded by the polling equipment of the individual voter.

In another embodiment of the invention, the system further comprises means for generating and storing a reference service identity code for each individual voter entitled to the election, which reference service identity code is calculated from a fixed part of the unique personal key of the voter and information related to the election and means for keeping a status record of the voter at the means for receiving and collecting the virtual ballot forms, wherein the status record is associated with the reference service identity code of the voter.

In a preferred embodiment of the invention, the tool to be loaded in the polling equipment of the voter is arranged for calculating a service identity code from the fixed part of the unique personal key of the voter and the information related to the election and for forwarding the service identity code to the means for receiving and collecting the virtual ballot forms.

The status record provides a possibility to track whether a voter has already taken part in the vote, whether the voter has or has not completed the voting, etc. by comparing the stored reference service identity code and the calculated service identity code, all this without revealing the voter's identity.

The personal keys have to be communicated to the voters. In accordance with a yet further embodiment of the invention, communication means for communicating the unique personal key to each individual voter entitled to the election are provided, the communication means comprises at least one of a group including means for electronically storing the unique personal key in a chip card of the voter, data communication means for communicating the unique personal key to the voter by a data network such as the Internet or a fixed and/or mobile data communication network including a Short Message Service, and means for providing the unique personal key in a human and/or machine readable form on a hard copy, such as a text message on paper, for communicating by mail to the voter.

In order to enter the personal key, in another embodiment of the invention, the polling equipment is arranged for operatively connecting same to data input means comprising at least one of a group including a chip card reader, a keyboard, a mouse, a screen, a bar code reader and voice conversion means.

An important advantage of this embodiment according to the invention is that the electronic voting system can be combined with an existing ordinary mail or postal election system. All eligible voters may receive both the capability to vote by mail or to vote electronically, by forwarding an election package by mail. In this election package they will find a postal ballot-form and an Internet Voting Card. The voter will have the free choice to select the best option for himself without any prior registration.

Accordingly, the design of the electronic voting system of the invention has to reflect the combination of Internet and mail voting and should be capable of coping with all kind of potential discrepancies, created by the combination of these two systems, e.g. voters who take part using both channels, i.e. the mail and the Internet, etc. In addition, the individual voter should have the possibility to validate that also his mail vote is reflected in the final outcome.

In another embodiment of the electronic voting system according to the invention, the means for receiving and collecting virtual ballot forms are arranged for receiving and collecting virtual ballot forms other than forwarded by polling equipment of a voter, such as physical ballot forms received by mail, and comprising reading and conversion means for converting the physical ballot forms into virtual ballot forms.

To avoid double voting, i.e. double counting of votes of the same voter, the means for verification and validating are arranged in such way that if a set of two or more virtual ballot forms associated with an identical voter identity code is collected and the virtual ballot forms are collected from means of different kinds that have been appointed different values of priority, only the virtual ballot forms collected from the means of the kind with the higher value of priority are submitted for verification and validation.

That is, the invention provides the possibility of allocating a processing priority to virtual ballot forms received via different channels. That is, for example, directly via the Internet, for example, or indirectly via the mail and scanning and conversion of the physical ballot forms.

In a yet further embodiment of the invention, the means for verification and validation are arranged in such way that physical ballot forms received by mail and which are converted into virtual ballot forms, are appointed the lower value of priority.

Thus, virtual ballot forms directly received via the Internet, for example, will be calculated as the eventually valid vote, in case the voter has used both the mail and the data network opportunity to vote.

It will be appreciated that the system according to the invention supports voting, by different means either electronically and by mail. However, by using the validating means according to the invention, always a single vote will be counted. Also in the case of voting by different electronic means. Note that the election is to be performed in a set time window. Votes received outside the time window will be invalid, of course.

As already disclosed above, to enhance the security of the system, the means for generating a unique subject identity code for each subject to be elected in the election, the means for generating a unique voter identity code and the means for generating a reference election record for each individual voter entitled to the election preferably comprise cryptographic generator and calculator means.

Likewise, the means for generating a unique subject combination identity code for each combination of subjects to be elected in the election, the means for generating a unique voter identity code and the means for generating a reference election record for each individual voter entitled to the election preferably comprise cryptographic generator and calculator means.

The cryptographic generator and calculator means are preferably arranged for symmetric encryption, such as DES, triple DES and AES, for example.

In a practical embodiment of the electronic voting system according to the invention, the means for presenting the list of subjects from which one subject or one combination of subjects is to be elected by the voter at the polling equipment, the means for loading the tool in the polling equipment of a voter, the means for receiving and collecting the virtual ballot form forwarded by the polling equipment and the confirmation means are supported by computer equipment comprising at least one computer server.

In a preferred embodiment of the invention, in order to enhance safety and security, to prevent fraud as much as possible, the or each of the means for loading the tool in the polling equipment of a voter, the means for receiving and collecting the virtual ballot form forwarded by the polling equipment, the confirmation means and the polling equipment are arranged for providing secure data transmission over the data network.

The invention further provides that the means for generating a unique personal key for each individual voter, the means for generating the unique voter identity code for each individual voter, the means for generating the unique identity code for each subject or combination of subjects to be elected in the election, the means for generating the reference election record for each individual voter entitled to the election, the means for verifying the collected virtual ballot form of the individual voter with respect to its presence in the reference election record of the voter, the means for counting votes of the voters, the means for validating votes from the collected virtual ballot forms and the means for establishing an election-result based on the counted votes are supported by computer equipment arranged to be operated under the supervision of an election authority.

This provides as much as possible control and inspection, to ensure anonimity of the user and to avoid tampering with the election results.

The polling equipment comprises at least one of a group including a personal computer and fixed or mobile data communication equipment arranged for providing access to the data network, such as the Internet.

In a second aspect, the inventions provides a method for electronic voting, for collecting and counting votes from individual voters using electronic polling equipment in an election comprising a list of subjects to be elected, from which list one subject is to be elected by an individual voter, the votes being forwarded by means of a data network, the method comprising the steps of:
generating a unique personal key for each individual voter entitled to the election;
communicating the unique personal keys to the individual voters;
generating a unique subject code for each subject on the list of subjects to be elected in the election;
generating a reference election record for each individual voter comprising all potential virtual ballot forms for the individual voter, wherein a unique voter identity code is calculated for the individual voter from a unique code for the election and the unique personal key of the voter, a unique subject identity code for each subject on the list of subjects to be elected by the voter in the election is calculated from the unique subject codes and the unique personal key of the voter, the calculated identity codes forming part of the virtual ballot forms;
storing the reference election records for the individual voters;
loading a tool in the polling equipment of a voter;
electing one subject from the list at the polling equipment of the individual voter, by inputting the unique personal key communicated to the voter and the unique subject code for the one elected subject into the polling equipment;
generating a virtual ballot form using the tool loaded into the polling equipment of the voter, wherein a unique voter identity code is calculated from the election code and the unique personal key of the voter, wherein a unique subject identity code is calculated from the unique subject code for the one subject elected by the voter from the unique subject code of the one subject elected and the unique personal key of the voter and wherein the calculated identity codes form part of the virtual ballot form;
forwarding the virtual ballot form over the data network;
receiving and collecting the virtual ballot form forwarded by the polling equipment;
verifying each collected virtual ballot form with respect to its presence in the reference election records of the voters;
counting votes, and
establishing an election-result based on the counted votes, characterized by a step for validating votes from the collected virtual ballot forms in such way that, if a set of two or more virtual ballot forms associated with an identical voter identity code is collected, one virtual ballot form of the set is validated as one single valid vote of the voter and the remaining virtual ballot forms of the set are marked as duplicate, provided that the virtual ballot forms of the set are identical as to the one subject elected by the voter, otherwise the virtual ballot forms of the set are marked invalid.

In the case of collecting and counting votes from individual voters using electronic polling equipment in an election comprising a list of subjects to be elected, from which list one combination of subjects is to be elected by an individual voter, in accordance with an embodiment of the method according to the invention, the step for validating votes from the collected virtual ballot forms is arranged such that if a set of two or more virtual ballot forms associated with an identical voter identity code is collected, one virtual ballot form of the set is validated as one valid vote of the voter and the remaining virtual ballot forms of the set are marked duplicate, provided that the virtual ballot forms of the set are identical as to the one combination of subjects elected by the voter, otherwise all virtual ballot forms of the set are marked invalid.

The method according to the invention, in various embodiments thereof, further provides delivery of a receipt after voting, publication of a list of voters entitled to the election, publication of the election result for checking by a voter whether his or hers vote has been properly counted in the result, providing a reference service identity and a service identity for checking the status of the voting process of a user, voting by mail and/or electronically, priority vote counting and cryptographic algorithms and codes, election under supervision of an election or vote counting authority, the use of modern communication means like SMS, Internet, mobile and fixed telephone facilities, as well as providing hard copies of ballot forms to the registered voters. In the case of a hard copy of the ballot form, the hard copy is suitable to be cast as a physical ballot form comprising the subjects or the combinations of subjects to be elected by the voter. Such as disclosed above in relation to the electronic voting equipment.

In the case of communicating the personal key to the voters by mail, using the above-mentioned election package comprising a postal ballot-form and an Internet Voting Card, replacement election packages should be offered to complaining eligible voters, who claim to have not received their package.

In such a case, in accordance with an embodiment of the method according to the invention, a reserve-list of a limited number of unique reserve keys is generated and the reference election record is generated to comprise virtual ballot forms for the number of unique reserve keys, and wherein a reserve key of the reserve-list is issued to a voter who applies for a fresh unique key replacing the unique personal key initially appointed to the voter, wherein the reserve key is appointed to the voter after the initially appointed unique personal key and the corresponding reference election record is withdrawn, and wherein the issue of the reserve key from and the withdrawal of the initially appointed unique personal key are taken into account for the verification of the validity of collected virtual ballot forms. Original voting capabilities are marked as invalid.

The replacement procedure should allows for the translation of voters real identity into the proper impersonal reference identity of that voter, in such a way, that the voter's election identity will remain secret. Proper publication of the activities around the replaced packages is required.

It will be appreciated that the replacement process is likewise applicable if the unique voter identity is not delivered by mail, i.e. as an election package, but by SMS, email, or otherwise.

The invention further provides that the tool is loaded automatically into the polling equipment from the data network. In an embodiment of the invention, wherein the data network comprises the Internet and the polling equipment comprises a personal computer operatively connected to the Internet, the tool is loaded into the personal computer by means of a Java applet included in a web-page to be selected by a voter for participating in the election.

Actually, the tool may be loaded in parts to avoid annoyance of the voters in the case of slow internet connections, for example. The parts may be divided such that, while a second part is downloaded, the voter is requested to respond to an already loaded first part, for example by inputting his personal key in two or more parts. In practice, the Java applet will be as small as a few kbytes.

In accordance with another embodiment of the method of the invention, the tool is loaded in a SIM-card of a GSM communication equipment, for example, for participating in the election by a voter using this communication equipment.

In a third aspect, the invention relates to a computer program product, comprising program code means stored on a computer readable medium, for performing the or part of the steps according to the invention as disclosed above, if loaded into an internal working memory of a computer and operated by the computer.

In accordance with the invention, the computer program product may be arranged as a tool for loading into a computer program running on a computer controlled polling equipment for performing the steps of the invention as disclosed above, if loaded into an internal working memory of a computer and operated by the computer.

The invention will now be disclosed in more detail, in a non-limiting manner, using a schematic drawing of the electronic voting system as whole.

### BRIEF DESCRIPTION OF THE DRAWINGS

The FIGURE shows, in a general and schematic manner, an embodiment of an electronic voting system according to the invention.

### DETAILED DESCRIPTION OF THE INVENTION

In the FIGURE, reference numeral 1 indicates, as a whole, in a general and schematic manner, an electronic voting system for collecting and counting votes from individual voters, in accordance with the present invention. The equipment operated and controlled by a vote collecting authority or a polling office or a polling committee or the like, and the polling equipment of the voters connect, in the embodiment shown, via a data network 2, such as the Internet.

Reference numeral 3 designates means for generating a unique personal key for each individual voter entitled to the election. Such voters are defined in means 33, the eligible voters file, which relate to means 34, the eligible voters list. This personal key is to be communicated in protected form to the individual voter. To this end, the personal key generator means 3 connect to communication means 4, for communicating the personal key in protected form via the data network 2, via a mobile radio network, such as GSM-network, via a landline telephone network, such as the PSTN (Public Switched Telephone Network) or the ISDN (Integrated Services Digital Network) or any other means, including mail 5 for communicating the personal key by a mail package to the individual voter. Therefore, the means 33 connect to the communication means 4 as well.

Reference numeral 6 denotes means for generating a unique subject code for each subject on a list of subjects to be elected in the election. Subjects in accordance with the present invention, may be persons, such as for an election of a public body, but can be also opinions to be elected in an opinion pole and the like. The list of subjects is schematically indicated with reference numeral 7.

For generating a reference election record, means 8 are provided which cooperate which means 9, for generating a unique voter identity code for the individual voter, calculated from a unique election code, schematically indicated by reference numeral 10, and the unique personal key of the voter as generated by the means 3 for generating the personal key. Further, the means for generating the reference election record 8 cooperate with means 11 for generating a unique subject identity code for each subject on the list of subjects 7 to be elected by the voter. The means 11 connect to the means 6 for generating the subject codes and the means 3 for generating the personal key of a voter.

The means 8 connect to memory means 12 for storing the reference value of all potential virtual ballot forms for each individual voter, which reference values are associated with the identity codes generated by the means and 9 and 11.

In accordance with the present invention, each user which would like to avail himself of the possibility of electronic voting, has to use a polling equipment 20, such as the personal computer (PC) of a voter. However, it will be appreciated that other electronic equipment by which a voter is able to communicate via the data network 2 and which provides means 29 for inputting data, such as a keyboard or any other means for making a vote, such as a touch screen or pointing device, can be used with the present invention.

In order to take part in the election, a tool 21 has to be loaded in the polling equipment 20 of the individual voter, such as schematically indicated by broken lines 21. The tool 21 is to be communicated from the vote collecting authority via the data network 2 to the polling equipment 20. To this end, the vote collecting authority is provided with means 22 for forwarding the tool 21 to the polling equipment 20. The means 22 could, for example, be a tool to make both the tool 21 and the list of subjects 7 of the subject codes generator means 6 as a part of, for example, Web-server means 13, i.e. the ballot-box server. The polling equipment 20 is provided with means 23 for receiving and downloading the tool 21 into the polling equipment 20. The tool 21 can be communicated, for example, using known Web browser software and could, for example, be a script, running in the Web browser.

The tool 21, which is in fact a software program of a few kbytes, will be loaded into the polling equipment 20, before the voter enters any secret or personal information, like or his/hers choice for a subject in the election. The personal key may be loaded into several parts, in order to facilitate the downloading of the tool 21. It will be appreciated that the tool 21 may be loaded directly into the polling equipment 20, in the case of data network connections with are sufficiently fast. The tool must guarantee that the voters personal key will only be entered in the polling station itself and never be transmitted out of that, for instance never transmitted to the polling server. The tool will only transmit the virtual ballot and status identity information to the polling server.

With the tool 21 loaded into the polling equipment of the voter, means 24 are established in the polling equipment 20 for calculating the unique voter identity code of the voter, from the unique personal key communicated to the voter and the election code 10, which can be communicated to the voter by mail 5, for example, or electronically via the communication means 4, or be incorporated in the tool 21.

The voter is now able to elect a subject or a combination of subjects, which are presented on the polling equipment 20 by the vote collecting authority, to which end Website means or a ballot-box server 13 may be installed at the voter collecting authority or another body which is responsible for the election. The means 13 are arranged for presenting a subject to be elected by a voter and—if desired—as well as the transfer of the tool 21. It will be appreciated that the means 13 may be coupled or integrated in the means 8 for generating the reference election.

The means 25 incorporated with the polling equipment 20 by the tool 21, now calculate a unique subject identity code of the subject elected by the voter and the unique personal key of the voter and a virtual ballot form is generated comprising the calculated identity codes. To this end, the tool 21 may incorporate means 25 and 26 into the polling equipment or the means 24 or 25 may be arranged for calculating the virtual ballot form. In the FIGURE, the virtual ballot form is indicated by reference numeral 27 for illustration purposes. Note that the virtual ballot form 27 exists electronically.

The polling equipment 20 further is arranged for communicating the virtual ballot form 27 over the data network 2 to the vote collecting authority. To this end, the means 23 may be used by which the tool 21 is loaded into the polling equipment or separate means. The vote collecting authority is provided with means 14 for receiving a virtual ballot form, or the means 13 have the capability to receive the virtual ballot form 27 and to store the virtual ballot form 27 in means 35, a “received virtual ballot forms” file

The means 14 could connect to means 15 if so desired, for verifying each collected virtual ballot form with respect to its presence in the reference election record of the voters stored in the storage means 12. To this end, the means 15 may communicate with the means 8 and/or can be integrated into each other.

In accordance with the present invention, means 16 are provided, which connect to the verification means 15, for validating collected virtual ballot forms. The validating means 16 are arranged in such a way that, if a set of two or more virtual ballot forms 27 associated with an identical voter identity code is collected, only one virtual ballot form 27 of the set is validated as one valid vote of the voter and the remaining virtual ballot forms 27 of the set are marked as duplicate, provided that the virtual ballot forms of the set are identical as to the subject elected by the voter. Otherwise, all virtual ballot forms 27 of the set are marked invalid.

A set of ballot forms 27 can be collected by the means 14 due to data network problems, for example resulting therein that the virtual ballot form 27 of a voter is delivered twice or many more times at the votes collecting means 14.

The validating means 16 connect to means 17 for counting valid votes and for publishing the election result.

For confirmation of the receipt of a received vote, means 18 are provided, connecting to the means 17 for counting a valid vote. The means 18 may be arranged to communicate directly via data network 2 to the polling equipment 20 of the user or may use, for example the server means 13 to this end. The receipt confirmation may be also delivered by mail 5 to the voter. In the FIGURE, mail transport is schematically indicated by dot-dashed lines.

For safety purposes, the list 7 can be arranged for publishing of the voters entitled to the election and for publishing the election result comprising the record of the valid votes as awarded for the collected virtual ballot forms 27. Of course, separate means may be used for this purpose.

The system 1 comprises also scanning and conversion means 30, for scanning and converting hard ballot forms, received by mail The means 30 connect to the means 14

At the polling equipment 20, means 28 may be provided, for entering the personal key by other means than by keyboard, for example using a smart card reader, a credit card reader, or the like.

For control and safety purposes, means 19 may be provided, in a further embodiment of the invention, for generating and storing a reference service identity code for each individual voter entitled to the election. These means 19 are further arranged for keeping a status record of the voter, and connect to the means 14 for receiving the virtual ballot forms. It will be appreciated that the means 19 may comprise two or more separate means for this purpose.

In the FIGURE, a single polling equipment 20 is shown. One skilled in the art will appreciate that a plurality of voters using his or hers polling equipment can be connected to the data network 2 for taking part in the election.

Further, it will be appreciated that several of the means used by the vote collecting authority can be combined into a single processing means, for example, such as a single computer server.

For example, the means 13, 35, 14, 18, 22 could be arranged into a single computer server 31. Further, the means 3, 6, 8, 9, 10, 11, 12, 15, 16, 17, 19, 33, 34 may be arranged in a further computer server or computer equipment 32, such as schematically indicated by broken lines.

Further, the word “means” as used in the present specification may be construed as one or both hardware and software means, such as, but not limited to, a computer program product to be loaded into a working memory of a computer or polling equipment.

Those skilled in the art will appreciate that other groupings or more than two servers can be used, without departing from the invention. The invention is not limited to the means shown, nor to their internal/external connections and functions.

The method according to the invention, in a preferred embodiment thereof, wherein the personal voter keys are forwarded by ordinary mail and wherein mail and electronic voting via the Internet are allowed, using DES cryptographic techniques, also called DES Virtual Ballot System (DVBS) comprises the following steps.

Initialize Voter Secrets (Initial Preparation).

The Central Election Committee defines or establishes the following items:

1. Public operations:

a. ElID (Election Identity) name or election code for these elections.

b. Voters registry (that contains all eligible Voters V1 . . . Vn) with their public identities VnID and per voter the proper value of ParGp (Participation Group), if applicable.

c. List of candidates C1 . . . Cm for this election.

2. Secret operations:

a. Generate per voter a personal key Kp (Personal Voter Key) comprising, for example, two parts:
Kp=DESe (Kgenvoterkey,{VnID//ParGp//ElID}), wherein DESe means DES encryption and Kgenvoterkey is a Triple DES (3DES) 16 byte encrypted key generated by a vote key generator.

b. Calculate per voter: VPID, a voters secret voting code, and PW, a password, where both values are 34AN translations of both halves of Kp. (34AN is an AlfaNumeric 34 coding).

c. Checking on double VPID values and allocating VPID sequence numbers in a ParGp field of each voter, transforming that to an ExtParGp field (Extended Participation Group).

d. Calculating the proper, cumulative check digits/characters for the ExtParGp, VPID and PW fields and adding these values to those fields.

e. Production of Postal Ballot-forms and Voting Cards, in a closed envelope, addressed on the outside to the proper voter Vn; on the Postal Ballot-forms VPID, PW and ElID have been coded in machine-readable form, on the Voting Cards these values are printed in good, readable format.

f. Calculation of RnPotVote (Reference Virtual Ballot Form) for each Vn, existing of two parts:
i. Per voter one RnPID=MDC [DESmac (Kp, f(ElID))], a Reference Pseudo Identity for Voter n (reference security identity code), wherein DESmac is an MAC (Message Authentication Code) calculated with DES and MDC stands for Modification Detection Code.
ii. Per voter for each possible vote for candidate Cm
in this election RnCm=MDC [DESmac (Kp, f(Cm,ElID))], wherein RnCM is a Reference Candidatechoice m by voter.

g. Calculation of ReSPID (Reference Service Identity Code) per voter (ReSPID=MDC[DESmac{Kp, (ElID//ExtParGp)}]) and creation of an (empty) status-tracking file with ReSPID as key.

h. Generation and production of similar materials for Replacement Election Packages (RepElPac), with the following properties.
i. All with a special series of VnID's, referred to as VrID (a VnID out of a special series for RepElPac's).
ii. With the related VrID printed on the outside of the closed envelope.
iii. With a file or list of all VrID's of the produced RepElPac's (RepElPac Stock File).
iv. To be stored in a specially managed storage.
v. All related RnPotVote (Reference Potential Voter for Voter n) records are marked “not_issued”.
i. Total deletion and removal of all voter-related secret information, other then the closed envelope with the ballot forms.

3. Publication of the RnPotVote file, signed with the public key. This public key and its related root-certificate to validate it should be such that the validation will be done automatically in the client of the voter, without additional public key installation activities. An acceptable alternative will be to just hash the file with SHA-1 and to publish the proper hash through an out-of-band channel.

4. Mailing of all closed envelopes with the ballot-forms to all voters.

5. Proper start of one or more ballot-box and ballot-box-status servers and the reception point for postal ballots.

Vote Collecting (Submitting Votes by Voters)

As soon as the voter receives his closed envelope with the ballot-forms, he is or could be involved in the following actions:

1. He or she validates that the envelope is undamaged and unopened (if that is not the case he or she files for the Replacement Election Packages procedure).

2. He or she decides to vote by mail or by Internet (or not to vote at all).

3. In case of a postal vote, he or she marks the proper candidate on the postal ballot, puts the ballot in the supplied response-envelope and mails that envelope.

4. In case of an Internet vote he or she is engaged in following events:

a. Selects his Voting Card.

b. Starts a PC, connected to the Internet and an Internet browser.

c. Surfs to the proper Internet site (URL) for this election.

d. Observes the proper start of SSL (Reference Security Identity Code) and the proper authentication of the ballot-box server.

e. Receives through his browser automatically the first election page, containing a tool in JavaScript coding to operate the system.

f. Enters his ExtParGp, VPID and PW from his Voting Card in the proper fields of the first screen. The proper values are validated with the check digits/characters.

g. The JavaScript of the system calculates the ReSPID (Reference Service Identity Code) value for this voter and sends that to the ballot-box-status server; that server responds with a status record for this voter: either “votes received for one or more election-categories” or “open to vote”.

h. The ExtParGp field, in conjunction with the status information, now defines the proper sequence for his voting: one or more screens with candidates are presented to the voter.

i. In every screen the voter marks his choice.

j. When all choices are made a screen is presented that invites the voter to enter his PW once more. The proper value is validated with the check character.

k. The JavaScript program tool now calculates Kp (or Personal Voter Key) for this user and his Virtual Ballot, by calculating VnPID (Voter Identity Code) and VnCx (Subject Identity Code) for each election category, then sends the Virtual Ballot form to the ballot-box server.

l. The ballot-box server stores the received values VnPID and VnCx as a pair in sequential file. After storing the values it calculates a Vote Receipt Confirmation (VotRecCon): VotRecCon=DESmac (Kbbs_b, (VnPID//VnCx)) and stores the first (high order) 4 bytes of that value (VotRecConSvr) in a file, to be published after the elections. The last (low order) 4 bytes (VotRecConCnt) are transferred to the JavaScript program in the PC of the voter. Kbbs_b is a 3DES MAC generation key for BBS_b, i.e. Ballot Box server with identity b.

m. The JavaScript program tool produces the proper status to the voter.

n. In the last screen for the voter, the JavaScript program presents the filed Voting Pair(s) (or Virtual Ballot Form(s)) VnPID (Voter Identity Code) and VnCx (Subject Identity Code) values, in combination with the received VotRecConCnt. The voter can use this complete information after the election are closed to validate his contribution to the elections and is referred to as his Receipt Confirmation Value (VotValVal).

o. The voter is invited either to write down or print out the VotValVal for each category he voted for.

5. Due to network problems or heavy congestion at the ballot-box-status or ballot-box servers, long response times for the initial status or VotValVal might occur. (The initial status and the VotRecConCnt value in VotValVal are the only interactive elements in this Vote Collecting process). In practice this can result in two different cases:

a. At the beginning of the voting sequence the status information is not received, so the client is unclear if there has been an earlier (partly) completed voting session with the ballot-box server.

b. At the end of the voting sequence the voter does not see (timely enough) the proper status of completion and the related VotValVal values and is not convinced that his vote(s) were properly received at the ballot-box server.

To cope with these situations the voter is entitled to perform one of the following actions (or both if he or she prefers to do so):

1. He or she performs the entire voting sequence once more through a URL entry point that does not validate his previous status.

2. He or she files a postal vote.

As long as all his/hers votes are for the same candidate(s), the tally system will clearly detect his proper choice and count his/hers vote as one for the proper candidate.

Replacement Election Packages Procedure.

Any eligible voter, who claims not to have received his closed envelope with the ballot-forms or the reception of a damaged envelope, is entitled to request a Replacement Election Package. The following organizational and technical provisions will be in place to submit such a package to the voter and to mark the ballots form his original package as invalid.

1. At a Central Election Committee Helpdesk:

a. The complaining voter approaches the Central Election Committee Helpdesk and files his complaint.

b. The Helpdesk validates voters' identity, his eligibility as voter and establishes his VnID.

c. The Helpdesk reports the VnID to a Polling Office or Polling Committee, providing the election services under supervision of the Central Election Committe, called TTP Internetstemmen.

d. The Helpdesk issues the voter a closed RepElPac envelope and marks the corresponding VrID in the RepElPac Stock File as “issued”.

e. Note is taken that the combination VnID and VrID is NOT recorded in any way (e.g. this can be handled by two different, separated elements of the helpdesk)

f. All the Helpdesk activities in this matter are logged, but anonymously.

2. At TTP Internetstemmen:

a. The proper RnPotVote records are marked “invalid”.
i. From the Helpdesk the reported VnID's are received.
ii. Using an automated procedure, the corresponding Kp is calculated, then the related RnPotVote records.
iii. These records are marked “invalid”.
iv. A logging file is maintained, containing only impersonal information.

b. The proper RnPotVote records are marked “valid, issued”.
i. From the Helpdesk (through the RepElPac Stock File) the issued VrID's are received.
ii. Using an automated procedure, the corresponding RnPotVote records are accessed and marked “valid, issued”.
iii. A logging file is maintained, containing only impersonal information.

Tally (Calculating the Voting Results)

1. At the end of election TTP Internetstemmen performs the following actions;

a. Internet Votes:
i. They close all ballot-box and ballot-box-status servers, after receiving the proper order to close from the Central Election Committee.
ii. They sign the Internet-Received-Votes (IRecVote) and the VotRecConSvr files.
iii. They publish those files with their signature.

b. Postal Votes:
i. Close of the point for the postal ballots.
ii. Processing of all postal ballots:
   1. Counting all ballots.
   2. Automatic reading of all ballots, creating a Received Postal Ballot (RecPostBal) record per form, making a RecPostBal File.
   3. Correcting/adding records to this file of forms that create automatic processing problems.
   4. Discrepancy reporting on all reading problems and manual corrections.
   5. Sending the RecPostBal File and all reports in a secure way to TTP Internetstemmen Tally processing.
   6. TTP Internetstemmen calculates per RecPostBal record a proper VnPID-VnCx pair and appends that to the Postal-Received-Votes (PRecVote) File.
   7. Validation of the number of records processed with the received number of postal ballots and the reported discrepancies.
   8. Creation of a complete signed PRecVote file.
iii. Publication of that file with their signature.

c. Republication of the changed RnPotVote file.

d. Forwarding of all invalid votes to the Central Election Committee.

e. Forwarding of logs and discrepancy reports to the Central Election Committee.

2. The Central Election Committee performs the following actions:

a. Validation of logs, reports and invalid votes.

b. Proper calculation of the voting results by processing Received-Votes files in relation to the current RnPotVote file.
i. Proper processing and counting rules are observed:
   1. Combination of all RecVote files in one file; in this total RecVote file the complete origin and status of the Tally process is registered per voting pair.
   2. Sorting all vote pairs in this file in the order of VnPID, VnCx.
   3. Comparing every vote pair (after hashing the values with MDC to a RnRecVote) with the RnPotVote file and updating the status of the vote pair as found per group with equal RnPID.
      a. All invalid votes (with either an invalid VnPID or an invalid VnCx) are marked as ‘invalid”.
      b. In case of one valid vote pair for this VnPID: update vote record as countable vote.
      c. In case of multiple valid vote pairs for this VnPID:
         i. All from one source (internet or postal)?
         1. Yes; in case all equal: mark first as countable vote with proper Cm, all others as duplications
         2. No: mark all as invalid because of different votes
         ii. All valid votes from two sources: mark all votes from the source with the lowest priority as overruled, process the votes of the source with the highest priority as described in the step above.
   4. Perform a count of all countable vote records.

c. Publication of provisional election results.

d. Formal complaint steps.

e. Correction steps in the Votes-Received files as required.

f. Publication of these corrections.

g. Publication of the permanent election results.

Validating the Results of the Election

For validation purpose each voter should retain his Receipt Confirmation Value (VotValVal), which is presented to him at the last screen of his voting process in hexadecimal format and can then be printed.

At the beginning of the election the Reference Potential Votes (RnPotVote) published can be used by anyone to validate the number of potential voters and the number of candidates. In addition each individual voter can verify that his VPID can be validated through the file and that all his potential votes can be validated through the file.

The Tally process as conducted by the Central Election Committee can be performed by anyone with access to the published RnPotVote and Votes-Received files and the published rules for the elections.

Each individual voter can validate that his vote (the Virtual Ballot Form retained in his Receipt Confirmation Value (VotValVal)) is present in the RecVote file and therefore part of the formal outcome of the election.

In addition, all published logs and discrepancy records can be used by anyone to validate that operating procedures have been conducted as required. In particular the Replacement Election Packages procedure should be verified (e.g. the number of complaining voters should match the number of issued VrID's and the number of updates in the RnPotVote file; plausibility checks should be done on the number of complaining voters).

Handling of Vote Receipt Confirmation in Respect to Complains by Voters

In case of a complaint by a voter, that his vote is not present in the RecVote file, it is of major importance that his VotRecConCnt (the last part in his Receipt Confirmation Value or VotValVal) is validated. Since this is a DESmac, created by a 3DES key, this validation is a sensitive operation that should and could not be performed by any party with some kind of interest in the election results. In case of, the system TTP Internetstemmen will perform this task. TTP Internetstemmmen is the party that is responsible for the generation, installation and management of the 3DES keys in the first place and can do the validation in total independence of The Central Election Committee or any other authority.

If indeed the voter can present a valid vote pair (Virtual Ballot Form) with proper VotRecConCnt (Vote Receipt Confirmation for Client), that is not present in the RecVote file, then this is an absolute proof that votes have disappeared. TTP Internetstemmen will report that to the Central Election Committee, so the later can make a final decision on the validity of the total election result.

To prevent abuse by TTP Internetstemmen, the published VotRecConSvr (Vote Receipt Confirmation for Server) file creates an opportunity to validate that indeed the same DESmac key is used in the validation process as was used during the election.

A Pki based VotRecCon would allow for an easier validation process, but would require a significantly more powerful ballot-box server process. In the current view of the peak load on this server this is considered not to be acceptable.

Specific Requirements of the System and its Supporting Organization.

The Internet Election system, in combination with the supporting organizations, should provide for the following features. In addition, the major measures to obtain the features are shortly described. In some cases this description applies to several requirements.

1. Authentication: Only authorized voters should be able to vote.

a. All eligible voters receive a Voting Card by mail, that contains an impersonalized 8 alphanumeric character Voters secret Voting Code (VPID) and a randomly selected 8 alphanumeric character Password (PW), both unique to each voter.

b. In case of a complaint of and authorized user about the reception of his Voter Card, a new one will be made available to him. The original Voting Card will be rendered invalid and cannot be used to produce valid votes any more.

c. The voter can validate his VPID and PW before the election begins on the Internet through a published Reference Potential Votes (RnPotVote) file.

2. Convenience: Voters should be able to cast votes with minimal equipment and skills.

a. There is no requirement for the voter to register in advance the way he will cast his vote. At any moment the voter can decide to drop his effort to vote through the Internet and use his conventional ballot paper through the mail, as long as the latter is turned-in on time.

b. The system is based on the regular Internet facilities that are currently used by over 95% of the potential voters.

c. The actual Internet voting process for the voter is based on short directions on his Voting Card and a normal, interactive sequence of screens through his Internet browser.

d. During the sequence of screens the voter is free to interrupt his voting activities; a status screen gives him a simple and complete picture of the actual situation at a each moment of interruption and at the end of his voting session.

e. At the completion of his voting session, the voter receives an 8 alphanumeric character long Vote Receipt Confirmation (VotRecConCnt), that he can printout or write down in addition to his Virtual Ballot Form (VnPID//VnCx) and use in case of disputes about his voting action.

3. Secrecy: No one should be able to determine how any individual voted.

a. His or hers unique and impersonalized Voter Identity Code VnPID protects the actual voting identity of each voter; his Voting Card just contains impersonalized information about him.

b. The actual calculation and generation of the several sensitive voter-related data (e.g. VPID, PW) and the related Reference Potential Votes (RnPotVote) file is sensitive; the system allows for isolated processing of this data in a short time interval by an independent party (TTP Internetstemmen).

c. The preparation of Voting Cards and the mailing to the individual voter is sensitive as well and will be handled by an independent, specialized printing company.

d. Each vote of a specific voter for a specific candidate consists of a unique 16-byte string and can only be generated by the voter. The system (and anyone else) is able to determine its validity, but without any reference to the real identity of the voter.

e. During voters communication with the voting server the exchanged information is protected by SSL.

f. The voting server itself is set-up in a way, that neither Internet address information, nor any other information related to the sender of a vote is retained with that vote. TTP Internetstemmen will manage that server.

4. Uniqueness: No voter should be able to vote more than once.

5. Integrity: Votes should not be able to be modified without detection.

6. Accuracy: Voting systems should record the votes correctly.

7. Reliability: Systems should work robustly, even in the face of numerous failures.

a. In the system an individual vote is calculated by a script program in the browser of the client, based on secret information coming from the Voting Card. The main task of the election server is to initiate a reliable and confidential session with the client, to provide the client with the script program and candidate information, to receive and store the vote and to return a Vote Receipt Confirmation (VotRecConCnt) message. In addition, all messages are short. Both on the client and the server side there is no dependency on critical and complex components, like database technology, detailed interactivity, point-of-no-return counters and commit-roll-back mechanisms. Finally there is no need to concentrate all election traffic in one server, since there is no need to guard the voters activities at a single place; votes could even be received in parallel in different servers and all be combined at the end of the election. By nature this allows for the creation of a robust server setup in a simple and straightforward way.

b. In a multi component, Internet based election system one should take into account that the same message could arrive more then once. That could be caused accidentally by system components or on purpose in case of a system (component) restart or a voter that repeats his voting action in case of disturbances. The system allows for the reception of one or more votes for one election by the same voter, as long as all his valid votes are all the same.

c. The system counts all the same votes of one voter as one; valid, but different votes by one voter for several candidates are invalid (since that is comparable with a ballot paper with more then one box marked by the voter in the case where he can only vote for one candidate).

d. The system allows for the use of both mail and Internet votes by the same voter. First all invalid votes for this voter are dropped. In case the valid votes of a specific voter arrived both by mail and by Internet, the system will neglect the mail votes and compare the Internet votes. In case there is only one Internet vote or a set of equal votes, then one is counted as a vote for a specific candidate. In case of just valid mail votes from a specific voter have arrived, they are processed in a similar way. This way, mail voting could even be used as a back up for Internet voting.

e. The voting session is protected by SSL. This as done to protect against eavesdropping and to ensure the voter, that he is casting is vote with the proper ballot authority.

8. Verifiability: Should be possible to verify that votes are correctly counted for in the final tally.

a. At the beginning of the election the Reference Potential Votes (RnPotVote) file is published; this file can be checked by anyone on:
i. It's origin and integrity
ii. Its size (that should reflect the number of potential voters and the number of candidates) and by each individual voter on:
iii. The fact that his VPID can be validated through the file.
iv. The fact that all his potential votes can be validated through the file.

b. At the end of the election all received votes (RecVotes) are published; this file can be checked by anyone on:
i. It's origin and integrity.
ii. Its size (that should reflect the published turn-out for the election).
iii. The actual published election results, in combination with the earlier published RnPotVote file,

and by each individual voter, in combination with the earlier published RnPotVote file on.
iv. The fact that his vote is present in the RecVote file and therefore part of the formal outcome of the election.
v. The validation of the received Vote Receipt Confirmation (VotRecConCnt), through the Empire function of TTP Internetstemmen, in case of discrepancies.

9. Audit ability: There should be reliable and demonstrably authentic election records.

In addition to the features mentioned in relation to Verifiability, TTP Internetstemmen adds the following reports:

a. Reports on proper initiation of the election data and systems

b. Reports on proper Voting Card reissuing procedures

c. Reports on proper processing of the mail votes

d. Reports on all discrepancies handled by the Empire activities

e. Reports on the presentation of the formal results

f. File containing all VotRecConSvr values to validate all VotRecConCnt values and visa-versa

g. Presentation of (all) valid and invalid votes on request.

10. Non-coercibility: Voters should not be able to prove how they voted.

11. Flexibility: Equipment should allow for a variety of ballot question formats.

a. The system meets this requirement.

12. Certifiability: Systems should be testable against essential criteria.

a. Due to technical shortcomings, created by the given voter environment, the system by itself is unable to meet all requirements; therefore, just certifying the system will not guarantee a proper election process.

b. Some parts and functions of the system and its subsystems are certifiable.

c. Other parts out of the scope of the system should be judged as well, to obtain a complete impression on the reliability and controllability of the complete election process.

13. Transparency: Voters should be able to possess a general understanding of the whole process.

a. Any system with technical components will be hard to understand for the general public and at least will not come close to the understandability of a ballot-box election system.

b. In case the technical components could be validated and certified by an independent party; once that is accepted, the general public can have a general understanding and trust in the system design, since all functions map well on the basic interests of the individual voter.

14. Cost-effectiveness: Systems should be affordable and efficient.

a. The system can be performed with general Internet-browser type systems at the client site and relatively simple server components.

Above, the invention has been disclosed with reference to a preferred embodiment thereof. Those skilled in the art will appreciate that several modifications and additions can me made within the scope of the present invention as defined in the attached claims.

1-42. (canceled)

43. Electronic voting system for collecting and counting votes from individual voters using electronic polling equipment in an election comprising a list of subjects to be elected, wherein a vote of an individual voter comprises an election of one of a group including:
one subject of said list, in an election of a single subject, and
one combination of subjects of said list, in an election of a combination of subjects,
wherein said votes being forwarded by means of a data network, said electronic voting system comprising:
means for generating a unique personal key for each individual voter entitled to said election, which unique personal key is to be communicated to said individual voter;
means for generating one of a group including:
a unique-subject code for each subject on said list, in an election of a single subject, and
a unique subject combination code for each combination of subjects on said list, in an election of a combination of subjects;
means for generating a reference election record for each individual voter comprising all potential virtual ballot forms for said individual voter, by calculating a unique voter identity code for said individual voter from a unique election code for said election and said unique personal key of said voter, and by calculating one of a group including:
a unique subject identity code for each subject on said list, from each unique subject code and said unique personal key of said voter, in an election of a single subject, and
a unique subject combination identity code for each combination of subjects on said list from each unique subject combination code and said unique personal key of said voter, in an election of a combination of subjects,
and wherein said calculated identity codes form part of said virtual ballot forms;
means for storing said reference election records for said individual voters;
means for loading a tool in said polling equipment of said individual voter wherein said tool comprises means for calculating said unique voter identity code of said voter from said unique election code and said unique personal key communicated to said voter, for calculating one of a group including:
a unique subject identity code of a subject elected by said voter, from said unique subject code of said subject elected by said voter and said unique personal key of said voter, in an election of a single subject, and
a unique subject combination identity code for the combination of subjects elected by said voter, from said unique subject combination code for said combination of subjects elected by said voter and said unique personal key of said voter, in an election of a combination of subjects,
and for generating a virtual ballot form comprising said calculated identity code, using said polling equipment;
means for forwarding said virtual ballot form by said polling equipment over said data network;
means for receiving and collecting said virtual ballot form forwarded by said polling equipment;
means for verifying each collected virtual ballot form with respect to its presence in said reference election records of said voters;
means for counting votes;
means for establishing an election result, and
validating means for validating votes from said collected virtual ballot forms, which validating means are arranged in such way that from a collection of at least two virtual ballot forms associated with an identical voter identity code, one virtual ballot form of said collection is validated as one valid vote of said voter and remaining virtual ballot forms of said collection are marked as duplicate if said virtual ballot forms of said collection are identical as to one of a group including:
said subject elected by said voter, in an election of a single subject, and
said combination of subjects elected by said voter in an election of a combination of subjects,
and all virtual ballot forms of said collection are marked invalid if said virtual ballot forms of said collection are not identical as to one of a group including:
said subject elected by said voter, in an election of a single subject, and
said combination of subjects elected by said voter in an election of a combination of subjects.

44. Electronic voting system according to claim 43, wherein said validating means form part of said means for verifying said collected virtual ballot forms.

45. Electronic voting system according to claim 43, wherein said validating means form part of said means for counting said votes.

46. Electronic voting system according to claim 43, further comprising confirmation means for generating a receipt indicating that a virtual ballot form has been received from said polling equipment of said voter and means for delivering said receipt comprising a unique receipt confirmation value in readable form at said polling equipment of said voter.

47. Electronic voting system according to claim 43, further comprising means for publishing a list of voters entitled to said election, said list of subjects to be elected in said election and said reference election records for said individual voters, enabling public inspection before a date of said election, and entry means for each individual voter using said unique personal key for inspection of said reference election record for said individual voter.

48. Electronic voting system according to claim 43, further comprising means for publishing said election result, comprising a record of valid votes as awarded for said collected virtual ballot forms after been submitted for verification and validation, enabling public inspection, and entry means for each individual voter using the unique personal key for inspection of an account of said virtual ballot form forwarded by said polling equipment of said individual voter.

49. Electronic voting system according to claim 43, further comprising means for generating and storing a reference service identity code for each individual voter entitled to said election, which reference service identity code is calculated from a fixed part of said unique personal key of said voter and information related to said election and means for keeping a status record of said voter at said means for receiving and collecting of said virtual ballot forms, wherein said status record is associated with said reference service identity code of said voter.

50. Electronic voting system according to claim 43, wherein said tool to be loaded in said polling equipment of said voter is arranged for calculating a service identity code from a fixed part of said unique personal key of said voter and information related to said election and for forwarding said service identity code to said means for receiving and collecting said virtual ballot forms.

51. Electronic voting system according to claim 43, further comprising communication means for communicating said unique personal key to each individual voter entitled to said election, said communication means comprises at least one of a group including:
means for electronically storing said unique personal key in a chip card of said voter,
data communication means for communicating said unique personal key to said voter by a data network including Internet, a fixed, a mobile data communication network, including a Short Message Service, and
means for providing said unique personal key on a hard copy in at least one of a human readable form and a machine readable form, including a text message on paper, for communicating by mail to said voter.

52. Electronic voting system according to claim 51, wherein said hard copy is cast as a physical ballot form, further comprising said list of subjects to be elected by said voter.

53. Electronic voting system according to claim 43, wherein said polling equipment is arranged for operatively connecting same to data input means comprising at least one of a group including:
a chip card reader,
a keyboard,
a mouse,
a screen,
a bar code reader, and
voice conversion means.

54. Electronic voting system according to claim 43, wherein said means for receiving and collecting virtual ballot forms are arranged for receiving and collecting virtual ballot forms other than forwarded by polling equipment of a voter, including physical ballot forms received by mail and converted into virtual ballot forms by automatic ballot form reading and conversion means.

55. Electronic voting system according to claim 54, wherein said automatic ballot form reading and conversion are appointed a low value of priority.

56. Electronic voting system according to claim 55, wherein said means for verification and validating are arranged such that from a collection of at least two virtual ballot forms associated with an identical voter identity code and being collected by means that have been appointed differing values of priority, only virtual ballot forms having a higher value of priority are submitted for verification and validation.

57. Electronic voting system according to claim 43, wherein said means for generating one of a group including a unique subject code for each subject on said list, in an election of a single subject, and a unique subject combination code for each combination of subjects on said list, in an election of a combination of subjects; said means for generating a unique voter identity code; and said means for generating a reference election record for each individual voter entitled to said election comprise cryptographic generator and calculator means.

58. Electronic voting system according to claim 57, wherein said cryptographic generator and calculator means are arranged for symmetric encryption.

59. Electronic voting system according to claim 43, wherein said means for presenting said list of subjects at said polling equipment of a voter; said means for loading said tool in said polling equipment of a voter; said means for receiving and collecting said virtual ballot form forwarded by said polling equipment; and said confirmation means are supported by computer equipment comprising at least one computer server.

60. Electronic voting system according to claim 43, wherein said means for loading said tool in said polling equipment of a voter; said means for receiving and collecting said virtual ballot forms forwarded by said polling equipment; said confirmation means; and said polling equipment are arranged for providing secure data transmission over said data network.

61. Electronic voting system according to claim 43, wherein said means for generating a unique personal key for each individual voter; said means for generating said unique voter identity code for each individual voter; said means for generating said unique identity code for one of a group including a unique subject code for each subject on said list, in an election of a single subject, and a unique subject combination code for each combination of subjects on said list, in an election of a combination of subjects; said means for generating said reference election record for each individual voter entitled to said election; said means for verifying a collected virtual ballot form of said individual voter with respect to its presence in said reference election record of said voter; said means for counting votes of said voters; said means for validating votes from said collected virtual ballot forms; and said means for establishing an election result based on said counted votes are supported by computer equipment arranged to be operated under the supervision of an election authority.

62. Electronic voting system according to claim 43, wherein said polling equipment comprises at least one of a group including:
a personal computer arranged for providing access to said data network,
fixed data communication equipment arranged for providing access to said data network, and
mobile data communication equipment arranged for providing access to said data network.

63. Method for electronic voting, for collecting and counting votes from individual voters using electronic polling equipment in an election comprising a list of subjects to be elected, from which list an individual voter provides a vote by electing one of a group including:
one subject of said list, in an election of a single subject, and
one combination of subjects of said list, in an election of a combination of subjects;
forwarding of said vote by means of a data network,
generating a unique personal key for each individual voter entitled to said election;
communicating said unique personal keys to said individual voters;
generating one of a group comprising:
a unique subject code for each subject on said list, in an election of a single subject, and
a unique subject combination code for each combination of subjects on said list, in an election of a combination of subjects;
generating a reference election record for each individual voter comprising all potential virtual ballot forms for said individual voter, by calculating a unique voter identity code for said individual voter from a unique election code for said election and said unique personal key of said voter, and by calculating one of a group including:
a unique subject identity code for each subject on said list, from each unique subject code and said unique personal key of said voter, in an election of a single subject, and
a unique subject combination identity code for each combination of subjects on said list from each unique subject combination code and said unique personal key of said voter, in an election of a combination of subjects,
and wherein said calculated identity codes form part of said virtual ballot forms;
storing said reference election records for said individual voters;
loading a tool in said polling equipment of a voter;
electing from said list of subjects at said polling equipment of said voter one of a group comprising:
one subject of said list, in an election of a single subject, and
one combination of subjects of said list, in an election of a combination of subjects,
by inputting, into said polling equipment, said unique personal key communicated to said voter and one of a group comprising:
said unique subject code of said subject elected by said voter, in an election of a single subject, and
said unique subject combination code for said combination of subjects elected by said voter, in an election of a combination of subjects,
generating a virtual ballot form using said tool loaded into said polling equipment of said voter, by calculating said unique voter identity code from said election code and said unique personal key of said voter, for calculating one of a group including:
a unique subject identity code of a subject elected by said voter, from said unique subject code of said subject elected by said voter and said unique personal key of said voter, in an election of a single subject, and
a unique subject combination identity code for the combination of subjects elected by said voter, from said unique subject combination code for said combination of subjects elected by said voter and said unique personal key of said voter, in an election of a combination of subjects,
and wherein said calculated identity code forms part of said virtual ballot form;
forwarding said virtual ballot over said data network;
receiving and collecting said virtual ballot form forwarded by said polling equipment;
verifying each collected virtual ballot form with respect to its presence in said reference election records of said voters;
counting votes;
establishing an election result based on said counted votes, and
validating votes from said collected virtual ballot forms, in such way that from a collection of at least two virtual ballot forms associated with an identical voter identity code, one virtual ballot form of said collection is validated as one valid vote of said voter and remaining virtual ballot forms of said collection are marked as duplicate if said virtual ballot forms of said collection are identical as to one of a group including:
said subject elected by said voter, in an election of a single subject, and
said combination of subjects elected by said voter in an election of a combination of subjects,
and all virtual ballot forms of said collection are marked invalid if said virtual ballot forms of said collection are not identical as to one of a group including:
said subject elected by said voter, in an election of a single subject, and
said combination of subjects elected by said voter in an election of a combination of subjects.

64. Method for electronic voting according to claim 63, further comprising the step of generating a receipt comprising a unique receipt confirmation value in readable form indicating that a virtual ballot form forwarded over said data network has been received, and wherein said receipt is delivered at said polling equipment of said voter.

65. Method for electronic voting according to claim 63, further comprising the step of publishing a list of voters entitled to said election, said list of subjects to be elected in said election and said reference election records for said individual voters, enabling public inspection before a date of said election, and providing access for each individual voter using said unique personal key for inspection of said reference election record for said individual voter.

66. Method for electronic voting according to claim 65, further comprising the step of publishing said election result comprising a record of said valid votes as awarded for said collected virtual ballot forms after verification and validation, enabling public inspection and providing access for each individual voter using said unique personal key for inspection of a record of said vote for said virtual ballot form forwarded by said polling equipment of said individual voter.

67. Method for electronic voting according to claim 63, further comprising the steps of generating and storing a reference service identity code for each individual voter entitled to said election, wherein said reference service identity code is calculated from a fixed part of said unique personal key of said voter and information relating to said election, and keeping a status record for each individual voter in association with said reference service identity code.

68. Method for electronic voting according to claim 63, further comprising the steps of generating a service identity at said polling equipment of said voter, wherein said service identity code for said voter is calculated from a first part of said unique voter identity code of said voter and information relating to said election, using said tool loaded in said polling equipment of said voter, and forwarding said service identity code to said means for receiving and collecting said virtual ballot form.

69. Method for electronic voting according to claim 63, further comprising the step of receiving and collecting virtual ballot forms other than forwarded by said polling equipment of a voter, such as physical ballot forms forwarded by mail, and converting said physical ballot forms into virtual ballot forms using automatic ballot form reading and conversion means.

70. Method for electronic voting according to claim 69, wherein virtual ballot forms converted from physical ballot forms by said automatic ballot form reading and conversion means are appointed a low value of priority.

71. Method for electronic voting according to claim 70, wherein said step of validating is arranged such that from a collection of two or more virtual ballot forms associated with an identical voter identity code and said virtual ballot forms being collected from different means that have been appointed differing values of priority, only virtual ballot forms collected from means of a higher value of priority are submitted for validation.

72. Method for electronic voting according to claim 63, wherein said one of a group including a unique subject code for each subject on said list, in an election of a single subject, and a unique subject combination code for each combination of subjects on said list, in an election of a combination of subjects; said means for generating a unique voter identity code; and said means for generating a reference election record for each individual voter entitled to said election are cryptographically generated and calculated.

73. Method for electronic voting according to claim 72, wherein said identity codes and reference election records are generated and calculated for symmetric encryption.

74. Method for electronic voting according to claim 63, wherein said steps of generating said unique personal key for each individual voter; said unique voter identity code for each individual voter; said unique identity code for one of a group including a unique subject code for each subject on said list, in an election of a single subject, and a unique subject combination code for each combination of subjects on said list, in an election of a combination of subjects; said reference election record for each individual voter entitled to said election; said verification of a collected virtual ballot form of said individual voter with respect to its presence in said reference election record of said voter; said counting of said votes of said voters; said validating of votes from said collected virtual ballot forms; and establishing an election result based on said counted votes are performed under the supervision of an election authority.

75. Method for electronic voting according to claim 63, wherein said step of communicating said unique personal key to each individual voter entitled to said election comprises at least one of a group of steps including:
electronically storing said unique personal key in a chip card of said voter,
communicating said unique personal key to said voter by a data network including Internet, a fixed and a mobile data communication network including a Short Message Service, and
providing said unique personal key on a hard copy in at least one of a human readable form and a machine readable form, including a text message on paper, for communicating by mail to said voter.

76. Method for electronic voting according claim 75, wherein said hard copy is suitable to be cast as a physical ballot form comprising said list of subjects to be elected by said voter.

77. Method for electronic voting according to claim 63, wherein a reserve list of a limited number of unique reserve keys is generated and said reference election record is generated to comprise virtual ballot forms for said number of unique reserve keys, and wherein a reserve key of said reserve list is issued to a voter who applies for a fresh unique key replacing said unique personal key initially appointed to said voter, wherein said reserve key is appointed to said voter after said initially appointed unique personal key and said corresponding reference election record are withdrawn, and wherein said issue of said reserve key from and said withdrawal of said initially appointed unique personal key are taken into account for the verification of the validity of collected virtual ballot forms.

78. Method for electronic voting according to claim 63, wherein said polling equipment comprises at least one of a group including:
a personal computer arranged for providing access to said data network using browser software;
fixed data communication equipment arranged for providing access to said data network using browser software, and
mobile data communication equipment arranged for providing access to said data network using browser software,
and wherein said tool is loaded automatically into said polling equipment from said data network.

79. Method for electronic voting according to claim 63, wherein said data network comprises Internet and said polling equipment comprises a personal computer operatively connected to the Internet, wherein said tool is loaded into said personal computer by means of a Java applet included in a web-page to be selected by a voter for participating in said election.

80. Method for electronic voting according to claim 63, wherein said polling equipment comprises mobile communication equipment having a SIM-card and wherein said tool is loaded in said SIM-card of said mobile communication equipment for participating in said election by a voter using said mobile communication equipment.

81. Computer program product, comprising program code means stored on a computer readable medium, for performing said method according to claim 63, if loaded into an internal working memory of a computer and operated by said computer.

83. Computer program product, comprising program code means stored on a computer readable medium, arranged as a tool for loading into a computer program running on a computer controlled polling equipment for performing said method according to claim 63, if loaded into an internal working memory of said computer and operated by said computer.
